(19) United States
(12) Patent Application Publication
(10) Pub. No.: US 2016/0280445 A1
(43) Pub. Date: Sep. 29, 2016

(54) LIGHT POLARIZATION FILM, PACKAGING STRUCTURE AND METHOD FOR LIQUID CRYSTAL GLASS

(71) Applicant: Shenzhen China Star Optoelectronics Technology Co., Ltd., Shenzhen, Guangdong (CN)

(72) Inventors: Zhilin Zhao, Shenzhen, Guangdong (CN); Shihhsiang Chen, Shenzhen, Guangdong (CN)

(73) Assignee: Shenzhen China Star Optoelectronics Technology Co., Ltd., Shenzhen, Guangdong (CN)

(21) Appl. No.: 14/399,161

(22) PCT Filed: Aug. 28, 2014
(86) PCT No.: PCT/CN2014/085446

§ 371 Date: Nov. 6, 2014

(30) Foreign Application Priority Data
Aug. 26, 2014 (CN) 201410423991.4

(51) Int. Cl. B65D 81/127; G02F 1/1368; B65B 5/10; G02F 1/1335; B65B 23/20; B65D 85/48

(52) U.S. Cl. CPC B65D 81/127; B65B 23/20; B65D 85/48; B65B 5/10; G02F 1/133528; G02F 1/133514; G02F 1/1368

(57) ABSTRACT

A packaging structure for a polarizer is provided. The polarizer includes a light polarization film having two surfaces, a buffering layer attached on one surface of the light polarization film, and a separation layer attached on the other surface of the light polarization film. The buffering layer is a micro-foaming polyethylene (PE) film. The thickness of the micro-foaming polyethylene (PE) film ranges from 0.12 mm to 0.3 mm. The present invention also provides a packaging structure for a liquid crystal glass and a packaging method for packaging multiple liquid crystal glasses into a packaging box. The present invention use micro-foaming polyethylene (PE) film to replace the protection layer of the conventional liquid crystal glass. The fabrication process of the liquid crystal glass is reduced. The packaging material is also reduced such that a function for simultaneously protecting the light polarization film and the liquid crystal glass is achieved.

### BACKGROUND OF THE INVENTION

1. Field of the Invention

The present invention relates to the field of packaging for liquid crystal glasses, and more particularly to a light polarization film, and a packaging structure and method for a liquid crystal glass.

2. Description of Related Art

Currently, in the liquid crystal display (LCD) industry, the packaging method for the liquid crystal glass is basically by an integrated packing method, that is, multiple liquid crystal glasses are packaged in a box. Because each surface of the liquid crystal glasses is smooth, in order to ensure the adequate protection of each surface of the liquid crystal glasses and not affecting adjacent liquid crystal glasses when taking a liquid crystal glass out, each two liquid crystal glasses is separated by a spacer.

When using a box to package the liquid crystal glasses, the packaging cost is mainly depended on the number of the liquid crystal glasses and the spacers. When the number of the liquid crystal glasses is more, the cost allocated to each liquid crystal glass is less. The number of the spacers is equal to the number of the liquid crystal glasses. Therefore, the unit price of the spacers also affects the packaging cost directly.

Currently, in the LCD industry, the spacer for packaging the liquid crystal glass is basically made of expanded polyethylene (EPE) or polypropylene (PP). To reach the same buffering effect, the EPE spacer is thicker than the PP spacer. However, the unit price of the PP spacer is much higher than the EPE spacer.

To achieve the highest packaging efficient for the liquid crystal glass, two directions may work:

1. Increasing the number of the liquid crystal glass packaged in a single box; and

2. Decreasing the cost of the spacer.

In addition, a top and a bottom surface of the liquid crystal glass are both attached with a polarizer. Currently, a finished polarizer for selling includes at least three sheets laminated together and rolled up. The three sheets are respectively a protection layer as the top surface of the finished polarizer, a light polarization film, and a separation layer as the bottom surface of the finished polarizer. When attaching the polarizer to both side surfaces of a glass substrate, the separation layer is required to be removed first. When packaging multiple liquid crystal glasses, an additional buffer layer is provided between two liquid crystal glasses.

### SUMMARY OF THE INVENTION

In order to solve the problems of the conventional art, the present invention provides a polarizer having a simple structure and a low cost. The present invention also provides a packaging structure for a liquid crystal glass and a packaging method for packaging multiple liquid crystal glasses into a packaging box.

The present invention provides a packaging structure for a polarizer, comprising: a light polarization film having two surfaces; a buffering layer attached on one of the two surfaces of the light polarization film; and a separation layer attached on the other of the two surfaces of the light polarization film.

Wherein, the buffering layer is made of a foamed and soft buffering material.

Wherein, the buffering layer is a micro-foaming polyethylene (PE) film.

The present invention also provides a packaging structure for a liquid crystal glass, comprising: a color filter (CF) substrate; a thin-film-transistor (TFT) substrate disposed oppositely to the CF substrate; an upper light polarization film having two surfaces, and attached on the CF substrate; and a lower light polarization film having two surfaces, and attached on the TFT substrate; wherein, the other surface of the upper light polarization film or the other surface of the lower light polarization film is attached with a buffering layer.

The present invention also provides a packaging method for packaging multiple liquid crystal glasses into a packaging box, comprising: sequentially overlapping the multiple liquid crystal glasses into the packaging box, wherein, each of the multiple liquid crystal glasses has a top surface and a bottom surface, and at least one of the top surface and the bottom surface is attached with a buffering layer.

The present invention use micro-foaming polyethylene (PE) film to replace the protection layer of the conventional liquid crystal glass. The fabrication process of the liquid crystal glass is reduced. The packaging material is also reduced such that a function for simultaneously protecting the light polarization film and the liquid crystal glass is achieved.

### BRIEF DESCRIPTION OF THE DRAWINGS

FIG. 1 is a schematic diagram of a packaging technology for a polarizer according to a first embodiment of the present invention;

FIG. 2 is a schematic diagram of a packaging structure of liquid crystal glasses according to a first embodiment of the present invention;

FIG. 3 is a schematic diagram of packaging technology for a lower polarizer according to a second embodiment of the present invention; and

FIG. 4 is a schematic diagram of packaging structure of liquid crystal glasses according to a second embodiment of the present invention.

### DETAILED DESCRIPTION OF THE PREFERRED EMBODIMENT

The following content combines with the drawings and the embodiment for describing the present invention in detail.

### Embodiment 1

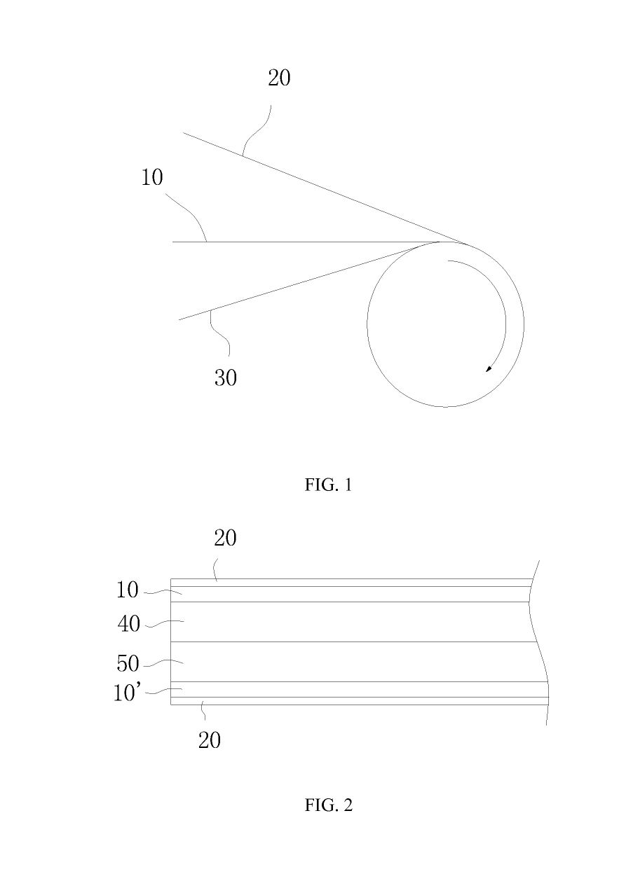

As shown in FIG. 1, when packaging a light polarization film 10, attaching a micro-foaming polyethylene (PE) film 20 with 0.12 mm thickness on a top surface of the light polarization film 10, and attaching a separation layer 30 on a bottom surface of the light polarization film 10. After laminating and rolling up, a finished polarizer is completed for backup and sale. As shown in FIG. 2, a liquid crystal glass substrate includes a color filter (CF) substrate 40 and a thin film transistor (TFT) substrate 50. When attaching the finished polarizer, an upper light polarization film 10 is attached first. At this time, removing the separation layer 30 on the bottom surface of the upper light polarization film 10, and attaching the upper light polarization film 10 on the top surface of the CF substrate 40. The micro-foaming PE film 20 attached on the other surface of the upper light polarization film 10 can function as a protection layer. Besides, a lower light polarization film 10′ is attached on the TFT substrate 50. At this time, removing the separation layer of the lower light polarization film 10′ and attaching the lower light polarization film 10′ on the bottom surface of the TFT substrate. The micro-foaming PE film 20 attached on the other surface of the lower light polarization film 10′ also functions as a protection layer. Therefore, the packaging structure of the liquid crystal glass is finished, that is, the two surfaces of the liquid crystal glass are all cover with the micro-foaming PE films 20 in order to function as a protection layer and buffering layer. When packaging multiple liquid crystal glasses to a packaging box, sequentially overlapping the multiple liquid crystal glasses such that between two liquid crystal glasses, there exists a buffering layer (that is, the micro-foaming PE film 20) for protection. When taking the liquid crystal glasses out, the protection on each surface of the liquid crystal glasses is enough, and will not affect or damage the adjacent liquid crystal glasses when taking a liquid crystal glass out.

The above-mentioned micro-foaming polyethylene film 20 is made of a polyethylene foaming material, the thickness may be 0.12 mm or even thinner. When the thickness is 0.12 mm, the buffering effect required by packaging the liquid crystal glasses into a box is reached. Of course, depending on the size and weight of the liquid crystal glass, the thickness of the micro-foaming polyethylene film 20 can be adjusted correspondingly. A better thickness ranges from 0.12 mm to 0.3 mm.

Comparing the conventional art with the present invention:

Assuming that the height of the internal diameter of the packaging box is 65 mm and a thickness of an liquid crystal glass is 1.5 mm, when using the existing EPE buffering spacer with a thickness of 1 mm, the packaging box can receive 25 pcs liquid crystal glasses; using the existing PP buffering spacer with a thickness of 0.35 mm, the packaging box can receive 35 pcs liquid crystal glasses. From the point of view of the number of the liquid crystal glasses which can be received in the packaging box, the efficiency of the PP buffering spacer is higher than the efficiency of the EPE buffering spacer. However, the unit price of PP buffering spacer is much higher than the unit price of EPE buffering spacer about 15 times price difference. As to the micro-foaming polyethylene film 20 of the present invention, using a thickness of 0.12 mm as an example, the packaging box can receive 40 pcs liquid crystal glasses. Therefore, the packaging box can receive more liquid crystal glasses. The cost of using the buffering spacer can be greatly reduced. The unit price of the micro-foaming PE film 20 is only a little higher than the unit price of the EPE buffering spacer. As a result, the packaging price is also significantly reduced. In addition, the present invention integral the micro-foaming PE film and the liquid crystal glass so as to save the operation process for the production line staff. The conventional “spacer-glass-spacer-glass . . . ” placement sequence is simplified to a “glass-glass-glass . . . ” placement sequence. The operation process is simpler, and the packaging efficiency can be higher.

### Embodiment 2

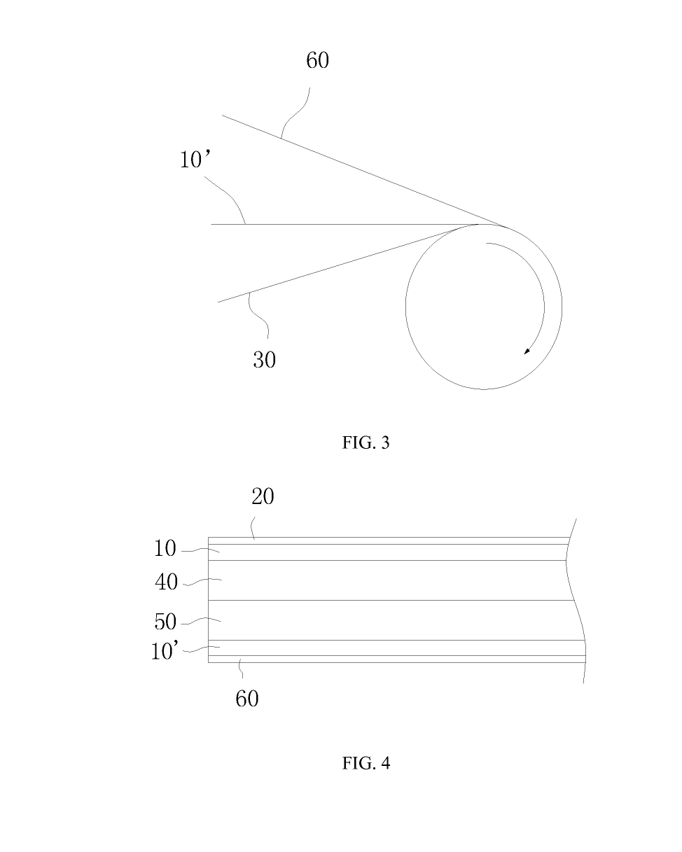

The light polarization film provided by the present embodiment has two ways for packaging, One way is respectively attaching the light polarization films on two surfaces of the liquid crystal glass, the light polarization films mentioned above is respectively an upper light polarization film 10 and a lower light polarization film 10′. As shown in FIG. 1, after attaching a micro-foaming PE film 20 on a top surface of the upper light polarization film 10 and attaching a separation layer 30 on a bottom surface of the upper light polarization film 10, the micro-foaming PE film 20, the upper light polarization film 10, and the separation layer 30 are laminated and rolled up for a backup. The other way is shown in FIG. 3, after attaching a protection layer 60 on a top surface of the lower light polarization film 10′ and attaching a separation layer 30 on a bottom surface of the lower light polarization film 10′, the protection layer 60, the lower light polarization film 10′, and separation layer 30 are laminated and rolled up for a backup.

Then, as shown in FIG. 4, a liquid crystal glass substrate includes a color filter (CF) substrate 40 and a thin film transistor (TFT) substrate 50. When attaching a light polarization film, attaching an upper light polarization film 10 on the CF substrate first. At this time, removing a separation layer 30 attached on the upper light polarization film 10 and attaching the upper light polarization film 10 to a top surface of the CF substrate. The micro-foaming PE film 20 attached on the other surface of the upper polarization film 10 can function as a protection layer. When attaching a lower polarization film 10′ on the TFT substrate, first, removing the separation layer 30 attached on the lower polarization film 10′ and attaching the lower light polarization film 10′ on a bottom surface of the TFT substrate 50. The other surface of the light polarization film 10′ is provided with a protection layer 60. When packaging multiple liquid crystal glasses, sequentially overlapping the multiple liquid crystal glasses, a protection layer 60 attached on a lower surface of an upper liquid crystal glass is overlapped on a micro-foaming PE film 20 attached on a top surface of a lower liquid crystal glass. Comparing with the embodiment 1, the micro-foaming PE film 20 which has the buffering effect has only one layer. Therefore, the thickness of the micro-foaming PE film 20 can be appropriately increased. In this embodiment, one surface of the liquid crystal glass does not have a buffering layer. However, the purpose of the present invention can also be achieved.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A packaging structure for a polarizer, comprising:
a light polarization film having two surfaces;
a buffering layer attached on one of the two surfaces of the light polarization film; and
a separation layer attached on the other of the two surfaces of the light polarization film.

2. The packaging structure for the polarizer according to claim 1, wherein, the buffering layer is made of a foamed and soft buffering material.

3. The packaging structure for the polarizer according to claim 2, wherein, the buffering layer is a micro-foaming polyethylene (PE) film.

4. A packaging structure for a liquid crystal glass, comprising:
a color filter (CF) substrate;
a thin-film-transistor (TFT) substrate disposed oppositely to the CF substrate;
an upper light polarization film having two surfaces, and attached on the CF substrate; and
a lower light polarization film having two surfaces, and attached on the TFT substrate;
wherein, the other surface of the upper light polarization film or the other surface of the lower light polarization film is attached with a buffering layer.

5. The packaging structure for the liquid crystal glass according to claim 4, wherein, the buffering layer is made of a foamed and soft buffering material.

6. The packaging structure for the liquid crystal glass according to claim 5, wherein, the buffering layer is a micro-foaming polyethylene (PE) film.

7. A packaging method for packaging multiple liquid crystal glasses into a packaging box, comprising:
sequentially overlapping the multiple liquid crystal glasses into the packaging box, wherein, each of the multiple liquid crystal glasses has a top surface and a bottom surface, and at least one of the top surface and the bottom surface is attached with a buffering layer.

8. The packaging method for packaging the multiple liquid crystal glasses into the packaging box according to claim 7, wherein, the buffering layer is made of a foamed and soft buffering material.

9. The packaging method for packaging the multiple liquid crystal glasses into the packaging box according to claim 8, wherein, the buffering layer is a micro-foaming polyethylene (PE) film.
